(19) United States
(12) Patent Application Publication
(10) Pub. No.: US 2009/0182906 A1
(43) Pub. Date: Jul. 16, 2009

(54) BROADCAST RECEIVER AND METHOD FOR REPRODUCING DATA OF EXTERNAL DEVICE USING THE SAME

(76) Inventor: Sung Jun CHO, Seoul (KR)

Correspondence Address: BIRCH STEWART KOLASCH & BIRCH, PO BOX 747, FALLS CHURCH, VA, 22040-0747, US

(21) Appl. No.: 12/272,449

(22) Filed: Nov. 17, 2008

(30) Foreign Application Priority Data
Jan. 10, 2008 (KR) 10-2008-0002997

(51) Int. Cl. G06F 3/00

(52) U.S. Cl. 710/33

(57) ABSTRACT

A broadcast receiver and a method for reproducing data of an external device using the same are disclosed. The method includes setting a virtual channel of the broadcast receiver for a data stream of the external device, transmitting the data stream of the external device and management information of the external device for managing the data stream from the external device to the broadcast receiver, format-converting the data stream and management information of the external device into a broadcast transport stream, decoding the data stream and the management information, and reproducing the data stream over the set virtual channel of the broadcast receiver using the management information.

This application claims the benefit of the Korean Patent Application No. 10-2008-0002997, filed on Jan. 10, 2008, which is hereby incorporated by reference as if fully set forth herein.

### BACKGROUND OF THE INVENTION

1. Field of the Invention

The present invention relates to a broadcast receiver and a method for reproducing data of an external device using the same, and more particularly, to a broadcast receiver which is capable of managing data of an external device in an integrated manner, and a method for reproducing data of an external device using the same.

2. Discussion of the Related Art

A television, which is a general broadcast receiver, can receive broadcast signals transmitted from broadcasting stations and provide the received broadcast signals to the user. A television recently introduced to the market is adapted to receive and provide various signals from external devices, as well as broadcast signals transmitted from broadcasting stations. External devices connectable to input terminals of this television may be, for example, an optical disc player such as a digital versatile disc (DVD) player or blu-ray disc (BD) player, a video cassette recorder (VCR), a personal computer (PC), etc.

However, because these external devices include management systems thoroughly different from that of the broadcast receiver, data of the external devices can be reproduced by the broadcast receiver only through format conversion or external input thereof. As a result, there is inconvenience in using the external devices connected to the broadcast receiver.

### SUMMARY OF THE INVENTION

Accordingly, the present invention is directed to a broadcast receiver and a method for reproducing data of an external device using the same that substantially obviate one or more problems due to limitations and disadvantages of the related art.

An object of the present invention is to provide a broadcast receiver which is capable of reproducing and managing a broadcast stream and a data stream stored in an external device in an integrated manner through one management system, and a method for reproducing data of an external device using the same.

Additional advantages, objects, and features of the invention will be set forth in part in the description which follows and in part will become apparent to those having ordinary skill in the art upon examination of the following or may be learned from practice of the invention. The objectives and other advantages of the invention may be realized and attained by the structure particularly pointed out in the written description and claims hereof as well as the appended drawings.

To achieve these objects and other advantages and in accordance with the purpose of the invention, as embodied and broadly described herein, a method for reproducing data of an external device comprises setting a virtual channel of a broadcast receiver for a data stream of the external device, transmitting the data stream of the external device and management information of the external device for managing the data stream from the external device to the broadcast receiver, format-converting the data stream and management information of the external device into a broadcast transport stream, decoding the data stream and the management information, and reproducing the data stream over the set virtual channel of the broadcast receiver using the management information.

The external device may be a blu-ray disc player. In this case, the format-converting may include removing a header from a source packet including the header and a transport packet. Also, the broadcast transport stream may be a moving picture experts group-2 (MPEG-2) transport stream.

The data stream may include information for a plurality of titles, and the management information may include management information for the plurality of titles.

The setting a virtual channel may include setting one virtual channel for each of the plurality of titles. In this case, the virtual channel set for each of the plurality of titles may be a minor channel.

The method may further include displaying broadcast reception channel information including information for the virtual channel set for the data stream.

The management information may include information for managing titles stored on a recording medium, and information for managing a playback time of the data stream.

The external device may include a portable multimedia player (PMP).

In another aspect of the present invention, a broadcast receiver comprises a channel setting unit for setting a virtual channel for a data stream of an external device, a stream conversion unitstream conversion unit for receiving the data stream of the external device and management information of the external device for managing the data stream from the external device and format-converting the received data stream and management information into a broadcast transport stream, a decoder for decoding the data stream and the management information, and a display unit for reproducing the data stream over the set virtual channel using the management information.

The stream conversion unitstream conversion unit may remove a header from a source packet including the header and a transport packet.

The channel setting unit may set one virtual channel for each of the plurality of titles.

The display unit may display broadcast reception channel information including information about the virtual channel set for the data stream.

It is to be understood that both the foregoing general description and the following detailed description of the present invention are exemplary and explanatory and are intended to provide further explanation of the invention as claimed.

### BRIEF DESCRIPTION OF THE DRAWINGS

The accompanying drawings, which are included to provide a further understanding of the invention and are incorporated in and constitute a part of this application, illustrate embodiment(s) of the invention and together with the description serve to explain the principle of the invention. In the drawings:

FIG. 1 is a block diagram showing the configuration of a broadcast receiver according to an exemplary embodiment of the present invention;

FIG. 2 is a flowchart illustrating a method for reproducing data of an external device, according to an exemplary embodiment of the present invention;

FIG. 3 is a schematic view showing a channel list including a virtual channel set for a stream of the external device; and

FIG. 4 is a schematic view showing the structure of a BD transport stream.

### DESCRIPTION OF SPECIFIC EMBODIMENTS

Reference will now be made in detail to the preferred embodiments of the present invention, examples of which are illustrated in the accompanying drawings. Wherever possible, the same reference numbers will be used throughout the drawings to refer to the same or like parts. Besides, although terms used in the present invention are possibly selected from the currently well-known ones, some terms are arbitrarily chosen by the inventor in some cases so that their meanings are explained in detail in the following description. Hence, the present invention should be understood with the intended meanings of the corresponding terms chosen by the inventor instead of the simple names or meanings of the terms themselves.

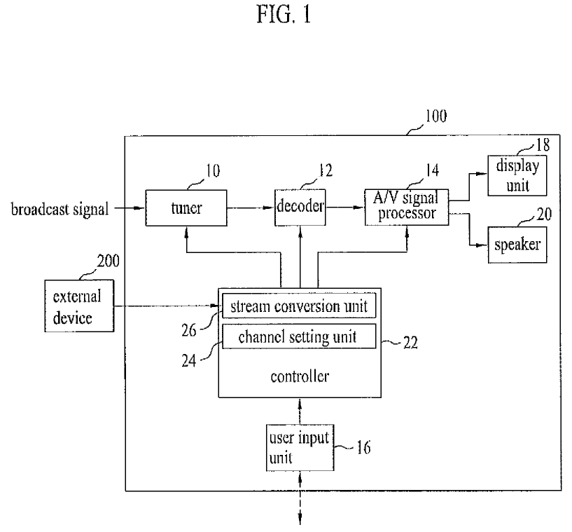

FIG. 1 is a block diagram showing a broadcast receiver 100 according to an exemplary embodiment of the present invention and an external device 200.

The broadcast receiver 100 according to this embodiment is an apparatus capable of receiving at least one of an analog broadcast signal, digital terrestrial broadcast signal, satellite broadcast signal and cable broadcast signal, which may be, for example, a set top box (STB) or digital television (DTV). FIG. 1 shows the configuration of the broadcast receiver 100 on the premise that the receiver 100 is a DTV.

The external device 200 may be an optical disc player such as a blu-ray disc (BD) player. Alternatively, the external device 200 may be a portable multimedia player (PMP) capable of storing audio, video and music data files of standards such as moving picture experts group (MPEG) in a predetermined storage space such as a hard disk drive (HDD).

In the case where the external device 200 is implemented with a PMP, it can reproduce data files stored therein through a display unit provided therein, and can be connected to various extension devices, such as a computer, TV, DVD player and projector, based on various connection standards, for example, integrated drive electronics (IDE), universal serial bus (USB), Institute of Electrical and Electronics Engineers (IEEE), etc.

As shown in FIG. 1, the broadcast receiver 100 comprises a tuner 10, decoder 12, audio/video (A/V)( [symbol] [symbol] ) signal processor 14, user input unit 16, display unit 18, speaker 20, and controller 22.

The tuner 10 receives a digital broadcast signal including a transport stream (TS). The digital broadcast signal received by the tuner 10 corresponds to one of a plurality of broadcast channels.

The decoder 12 parses the original video signal and audio signal from an A/V stream outputted from the tuner 10 or a stream conversion unitstream conversion unit 26 of the controller 22 under the control of the controller 22 and outputs the parsed video and audio signals to the A/V signal processor 14.

The A/V signal processor 14 processes the video and audio signals outputted from the decoder 12 and outputs the processed video and audio signals to the display unit 18 and speaker 20, respectively.

The user input unit 16 receives control commands inputted by the user. For example, the user input unit 16 may receive a channel change command and channel setting command from the user through input means such as a remote controller and output the received commands to the controller 22. The user inputs the channel setting command for the external device 200, which is then provided to a channel setting unit 24 of the controller 22 through the user input unit 16.

The display unit IS displays an image corresponding to the video signal outputted from the A/V signal processor 14 so that it can be visually recognized. The speaker 20 outputs the audio signal outputted from the A/V signal processor 14 so that it can be aurally recognized.

The controller 22 controls the entire operation of the digital broadcast receiver 100. Also, the controller 22 includes the channel setting unit 24 and the stream conversion unitstream conversion unit 26.

The channel setting unit 24 in the controller 22 sets a virtual channel for a data stream of the external device 200 in response to the channel setting command from the user input unit 16. The stream conversion unitstream conversion unit 26 receives a data stream and management information for managing the data stream, provided from the external device 200, and format-converts the received data stream and management information into a broadcast transport stream, for example, an MPEG-2 transport stream, which will be described later in detail.

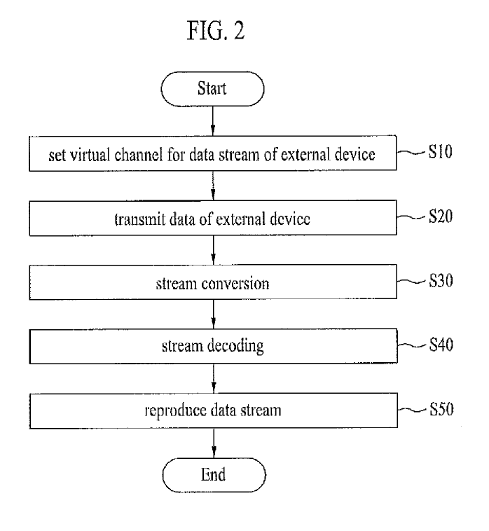

FIG. 2 is a flowchart illustrating a method for reproducing data of an external device, according to an exemplary embodiment of the present invention. Hereinafter, the external device data reproducing method according to the present embodiment will be described in detail with reference to FIG. 2.

First, a virtual channel of a broadcast receiver is set with respect to a data stream of an external device (S10) The virtual channel can be set based on the user's input.

Particularly, in the case where a plurality of external devices, for example, a BD player and a PMP are together connected to the broadcast receiver, one virtual physical channel is set for each of the external devices.

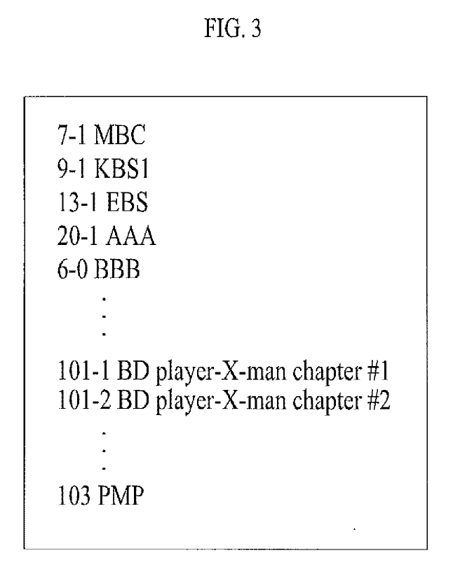

FIG. 3 shows an example of a channel list including a set virtual channel. As shown in FIG. 3, a list of the available external devices is included in the channel list together with the channel numbers set for the external devices. A BD player and a PMP are exemplified as the external devices in the drawing.

In the case where the data stream of the external device includes a plurality of titles or chapters, one virtual physical channel is set with respect to the data stream of the external device and one minor channel is set with respect to each of the titles or chapters, as shown in FIG. 3.

By setting the virtual physical channel for the data stream of the external device in the above manner, the user can conduct a channel change to any one of a digital channel, analog channel and the external device channel using one remote controller key, and reproduce data of the external device without format conversion thereof or a change to an external input thereof.

Meanwhile, information related to the available external devices may be displayed on a PIP (picture in picture) screen. In addition, streams provided by a broadcasting and the external device may be displayed simultaneously by using the PIP screen or a Split-Screen respectively.

The streams provided by the broadcasting and the external device may also be displayed simultaneously by using a display screen provided in a remote controller of the broadcast receiver.

Next, the data stream of the external device and management information for managing the data stream are transmitted to the broadcast receiver (S20). Particularly, in the case where the external device is a BD player, information of the broadcast receiver can be received from a PSIP/SI and management information of a BD can be received from an index.bdmv file, xxx.mpls file, etc.

In detail, information corresponding to a system time which is required by the broadcast receiver for managing the data stream can be obtained from information associated with a system time of the BD. Also, information for minor channel setting can be obtained from information about the number of titles of the BED and title IDs of the BD. Further, information corresponding to start and end times of a broadcast program can be obtained from a BD playback item. On the other hand, additional information about the titles may be obtained from meta data of the BD and displayed in an electronic program guide (EPG) of the broadcast receiver.

Next, the data stream and management information of the external device are format-converted into a broadcast transport stream so that they can be managed together with other broadcast transport streams by the broadcast receiver (S30).

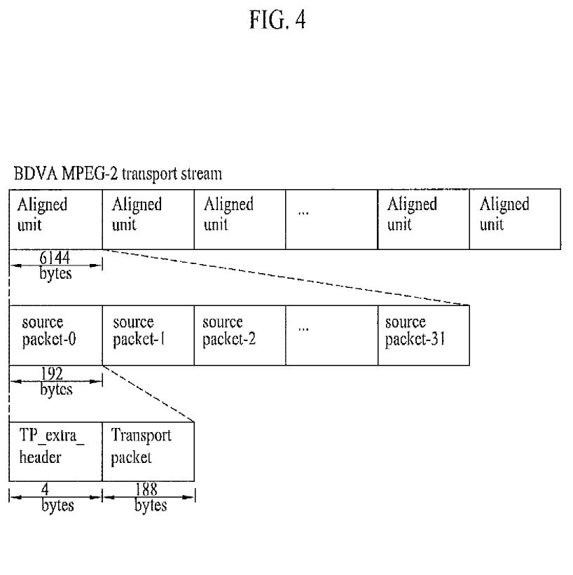

FIG. 4 shows the structure of a BD transport stream. As shown in FIG. 4, a source packet of the BD includes a 4-byte header TP_extra_header, and a 188-byte transport packet. Accordingly, in the case where the external device is a BD players a BD transport stream is format-converted into a 188-byte MPEG-2 transport stream, which has a broadcast transport stream format, by removing a header from a source packet of the ED transport stream, so that it can be decoded by an MPEG-2 decoder included in the broadcast receiver.

On the other hand, in the case where the external device is a PMP, streams of various file formats stored in the PMP are format-converted into broadcast transport streams, namely, MPEG-2 transport streams. However, when a file stored in the PMP has an MPEG-2 transport stream format which is a broadcast transport stream format, it can be decoded without conversion in stream format thereof.

Next, the data stream and management information of the external device, format-converted into the broadcast transport stream, are decoded by the decoder in the broadcast receiver (S40). At this time, the data stream of the external device is decoded in the same manner as the broadcast transport stream because it has the same format as that of the broadcast transport stream, as stated above.

Next, video and audio processing operations are performed with respect to the decoded data stream of the external device so that the data stream can be reproduced over the set virtual channel of the broadcast receiver (S50). At this time, the data stream can be reproduced using management information stored in the external device, which may be outputted, more particularly through the EPG of the broadcast receiver.

As apparent from the above description, according to the broadcast receiver and external device data reproducing method of the present invention, a digital broadcast stream and a data stream of an external device such as a ED player or PMP can be managed in an integrated manner by one system, thereby increasing the user's convenience.

It will be apparent to those skilled in the art that various modifications and variations can be made in the present invention without departing from the spirit or scope of the inventions. Thus, it is intended that the present invention covers the modifications and variations of this invention provided they come within the scope of the appended claims and their equivalents.

What is claimed is:

1. A method for reproducing data of an external device, comprising:
setting a virtual channel of a broadcast receiver for a data stream of the external device;
transmitting the data stream of the external device and management information for managing the data stream from the external device to the broadcast receiver;
decoding the data stream and the management information; and
reproducing the data stream over the set virtual channel of the broadcast receiver by using the management information.

2. The method of claim 1, wherein the external device is a blu-ray disc player.

3. The method of claim 2, wherein the step of format-converting comprises removing a header from a source packet including the header and a transport packet.

4. The method of claim 3, wherein the broadcast transport stream is a moving picture experts group-2 (MPEG-2) transport stream.

5. The method of claim 1, wherein the data stream includes information for a plurality of titles, and the management information includes management information for the plurality of titles.

6. The method of claim 5, wherein the setting a virtual channel includes setting one virtual channel for each of the plurality of titles.

7. The method of claim 6, wherein the virtual channel set for each of the plurality of titles is a minor channel.

8. The method of claim 1, further comprising displaying broadcast reception channel information including information for the virtual channel set for the data stream.

9. The method of claim 1, wherein the management information comprises:
information for managing titles stored on a recording medium; and
information for managing a playback time of the data stream.

10. The method of claim 1, wherein the external device includes a portable multimedia player (PMP).

11. The method of claim 1, further comprising:
format-converting the data stream and management information of the external device into broadcast transport streams.

12. A broadcast receiver comprising;
a channel setting unit configured to set a virtual channel for a data stream of an external device;
a stream conversion unitstream conversion unit configured to receive the data stream of the external device and management information for managing the data stream from the external device and format-convert the received data stream and management information into broadcast transport streams;
a decoder configured to decode the data stream and the management information; and
a display unit configured to reproduce the data stream over the set virtual channel using the management information.

13. The broadcast receiver of claim 12, wherein the external device is a blu-ray disc player.

14. The broadcast receiver of claim 13, wherein the stream conversion unitstream conversion unit configured to remove a header from a source packet including the header and a transport packet.

15. The broadcast receiver of claim 14, wherein the broadcast transport stream is an MPEG-2 transport stream.

16. The broadcast receiver of claim 15, wherein the data stream includes information for a plurality of titles, and the management information includes management information for the plurality of titles.

17. The broadcast receiver of claim 16, wherein the channel setting unit configured to set one virtual channel for each of the plurality of titles.

18. The broadcast receiver of claim 17, wherein the virtual channel set for each of the plurality of titles is a minor channel.

19. The broadcast receiver of claim 12, wherein the display unit configured to display broadcast reception channel information including information for the virtual channel set for the data stream.

20. The broadcast receiver of claim 12, wherein the management information includes:
information for managing titles stored on a recording medium; and
information for managing a playback time of the data stream.

21. The broadcast receiver of claim 12, wherein the external device includes a PMP.
